(19) United States
(12) Patent Application Publication
(10) Pub. No.: US 2017/0076079 A1
(43) Pub. Date: Mar. 16, 2017

(54) TERMINAL DEVICE BASED ON FINGERPRINT IDENTIFICATION, AND METHOD AND SYSTEM FOR LOGGING INTO TERMINAL DEVICE IN STANDBY STATE

(71) Applicant: Shenzhen Huiding Technology Co., Ltd., Shenzhen (CN)

(72) Inventors: Rui RAN, Shenzhen (CN); Qiyi HAO, Shenzhen (CN)

(21) Appl. No.: 15/342,103

(22) Filed: Nov. 2, 2016

Related U.S. Application Data
(63) Continuation of application No. PCT/CN2014/088284, filed on Oct. 10, 2014.

(30) Foreign Application Priority Data
May 14, 2014 (CN) 201410204545.4

(51) Int. Cl. G06F 21/32; G06F 3/0488; G06F 3/041

(52) U.S. Cl. CPC G06F 21/32; G06F 3/0416; G06F 3/04883

(57) ABSTRACT

The present invention discloses a method for logging in to a terminal device based on fingerprint identification in a standby state. The method includes the following steps: a fingerprint scanning and identification step: in the standby state, scanning and identifying fingerprint information input by a user; an awaking step: if the fingerprint information is successfully identified, awaking a control chip, and sending acknowledgement information indicative of successful fingerprint identification to the control chip; and an unlocking step: upon receiving the acknowledgement information indicative of successful fingerprint identification, unlocking, by the control chip, the terminal device, such that the user successfully logs in to the terminal device.

### CROSS REFERENCE TO RELATED APPLICATIONS

The present application is a continuation of international application No. PCT/CN2014/088284, filed on Oct. 10, 2014, which claims priority to Chinese Patent Application No. 201410204545.4, filed on May 14, 2014, both of which are hereby incorporated by reference in its entireties.

### TECHNICAL FIELD

The present invention relates to the technical field of terminal authentication and, and in particular, to a terminal device based on fingerprint identification, and a method and a system for logging into the terminal device in a standby state.

### BACKGROUND

With increasing privacy requirements of users on terminal devices such as mobile phones, tablet computers and the like, login function based on fingerprint identification is gradually integrated in such terminal devices as mobile phones and tablet computers.

However, with respect to a terminal device operating in a standby state, since the terminal device is in a dark screen state, the terminal device needs to be awoken before performing fingerprint identification. As illustrated in FIG. 1, the awaking process includes: step 1, awaking the terminal device when a power button or a Home button is pressed down, and waiting for unlocking of the terminal device based on fingerprint identification; step 2, scanning a fingerprint input zone to determine whether a fingerprint information is input, verifying the fingerprint information if fingerprint information is input by the user, logging in and entering the system of the terminal if the verification is successful.

Accordingly, the conventional login operation based on fingerprint identification needs two steps, and is thus somewhat complicated, which, to some extent, reduces user experience of the terminal device.

### SUMMARY

A method for logging in to a terminal device based on fingerprint identification in a standby state includes the following steps:

detecting, in the standby state, whether a touch operation is performed by a user on the terminal device;

scanning, when the touch operation is detected, fingerprint information input by the user;

awaking a control chip upon successful identification of the fingerprint information and sending acknowledgement information indicative of successful fingerprint identification to the control chip; or, awaking the control chip when the fingerprint information is scanned and identifying the fingerprint information by the control chip; and

unlocking, by the control chip, the terminal device to enable the user to log into the terminal device when the fingerprint information is successfully identified.

### BRIEF DESCRIPTION OF THE DRAWINGS

FIG. 1 is a schematic diagram of a conventional login process based on fingerprint identification;

FIG. 2 is an implementation flowchart of a method for logging into a terminal device based on fingerprint identification in a standby state according to a first embodiment of the present invention;

FIG. 3A and FIG. 3B are schematic diagrams of two customized touch operations for a touch operation detection electrode according to the present invention;

FIG. 4 is a complete flowchart of the login method in FIG. 2;

FIG. 5 is an implementation flowchart of a method for logging into a terminal device based on fingerprint identification in a standby state according to a second embodiment of the present invention;

FIG. 6 is a schematic diagram of a login process based on fingerprint identification according to the present invention;

FIG. 7 is a schematic diagram of a system for logging into a terminal device based on fingerprint identification in a standby state according to an embodiment of the present invention;

FIG. 8 is a schematic diagram of a system for logging into a terminal device based on fingerprint identification in a standby state according to the first embodiment of the present invention;

FIG. 9 is an appearance diagram of a fingerprint detection and identification module according to the present invention; and

FIG. 10 is a schematic diagram of a system for logging into a terminal device based on fingerprint identification in a standby state according to the second embodiment of the present invention.

### DETAILED DESCRIPTION

In order to make the objectives, technical solutions, and advantages of the present invention clearer, the present invention is further described in detail below by reference to the embodiments and the accompanying drawings. It should be understood that the embodiments described here are only exemplary ones for illustrating the present invention, and are not intended to limit the present invention.

With the fingerprint identification technology according to the present invention, even in a standby state, the fingerprint scanning and detection function may still be enabled; and once an input fingerprint is scanned, identification and awake actions may be triggered. The entire process only requires a user to perform a one-step operation.

FIG. 2 illustrates an implementation flowchart of a method for logging into a terminal device based on fingerprint identification in a standby state according to a first embodiment of the present invention, the method includes steps described in detail hereinafter.

In step S201, fingerprint scanning and identification is performed. Fingerprint input by a user is scanned and identified in a fingerprint scanning mode.

Considering that a great power energy is consumed when the terminal device maintains in the scanning and identification mode for a long time, prior to step S201, a touch gesture detection step, which consumes less power energy, may be implemented to detect, in the standby state, whether the user performs a touch operation; if it is detected that the user performs a touch operation, step S201 is performed. Before detection of the user's touch operation, the scanning and identification mode is not enabled.

In the present invention, in the standby state of such a terminal device as a mobile phone, a tablet computer and the like, a fingerprint detection and identification module enters a low power-consumption mode, which firstly enables a touch operation detection function only periodically. When it is detected that the user performs a touch operation, the fingerprint scanning and detection function is further enabled.

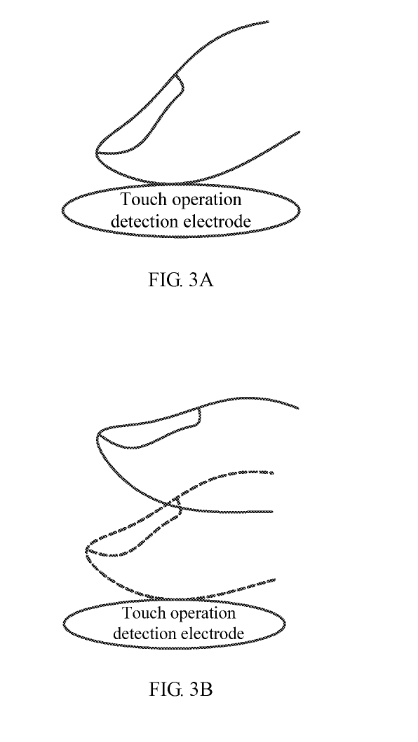

To prevent the mobile phone from being awoken by a mis-operation by the user, the present invention specifically defines a specific touch operation gesture to be distinguished from a normal operation. Only a touch operation conforming to rules may be considered to be valid. FIG. 3A and FIG. 3B respectively illustrates a long-press touch operation and a short-press double tap operation as examples. A touch operation detection electrode may be implemented by an annular emission electrode, which is specifically described hereinafter in this specification.

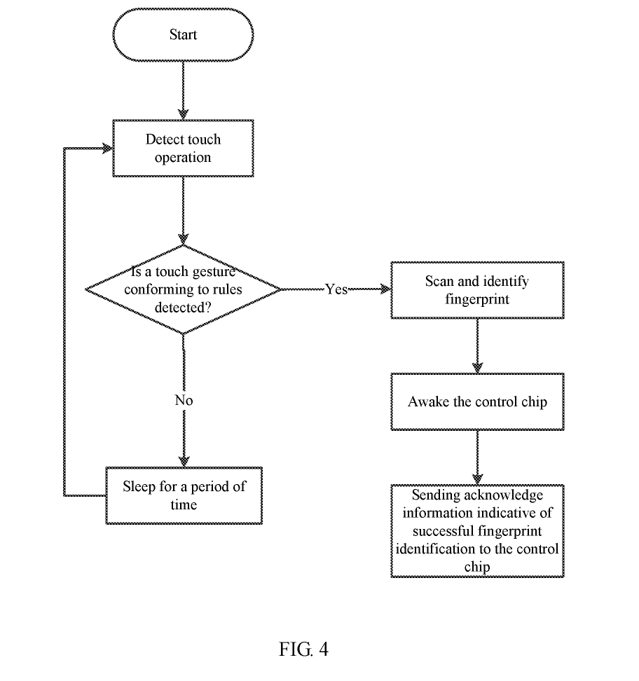

Further, if no touch operation conforming to the rules is detected, the terminal device enters a period of sleep time and temporarily stopping the touch gesture detection step. FIG. 4 illustrates a complete flowchart of the login method according to a first embodiment of the present invention.

In step S202, the terminal device is awoken. If the fingerprint information is successfully identified, a control chip is awoken, and acknowledgement information indicative of successful fingerprint identification is sent to the control chip.

In step S203, the terminal is unlocked. Upon receiving the acknowledgment information indicative of successful fingerprint identification, the control chip awakes the terminal device, and displays a picture indicating that the user has successfully logged into the terminal device.

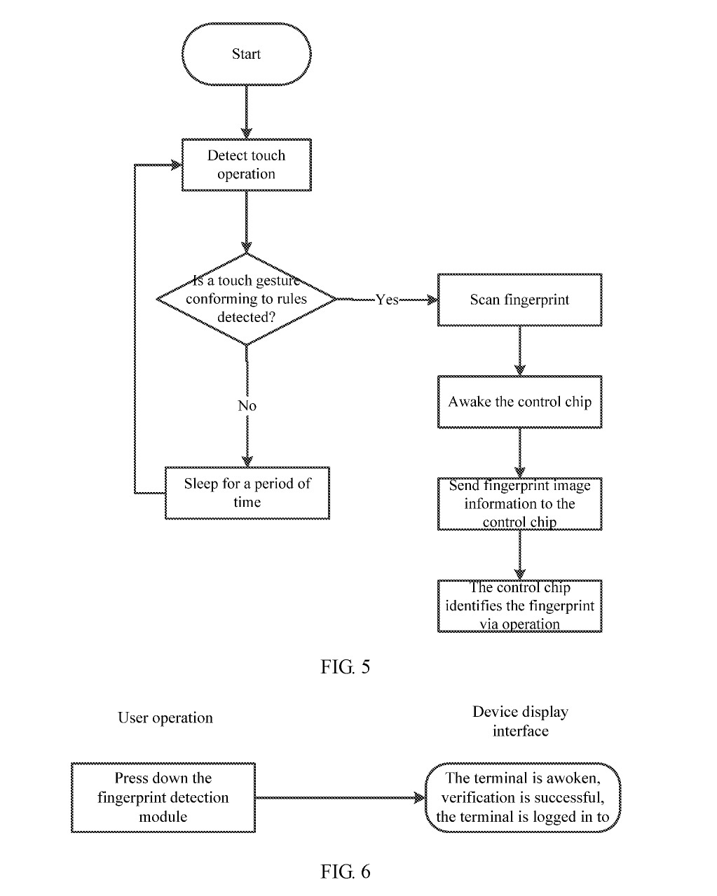

FIG. 5 illustrates an implementation flowchart of a method for logging into a terminal device based on fingerprint identification in a standby state according to a second embodiment of the present invention. Different from the first embodiment, in the second embodiment, a fingerprint image is identified by the control chip. Specifically, the fingerprint scanning and identification step is replaced by a fingerprint scanning step: upon detection of a touch operation performed by a user, entering a fingerprint scanning mode to scan whether the user inputs fingerprint information. The awaking step in the first embodiment is alternatively replaced by the following step: if it is scanned that the user inputs fingerprint information, awaking a control chip and sending the scanned fingerprint information to the control chip. The unlocking step in the first embodiment is alternatively replaced by the following step: identifying, by the control chip, the fingerprint information, and unlocking the terminal device upon successful identification of the fingerprint information, to enable the user to successfully log in to the terminal.

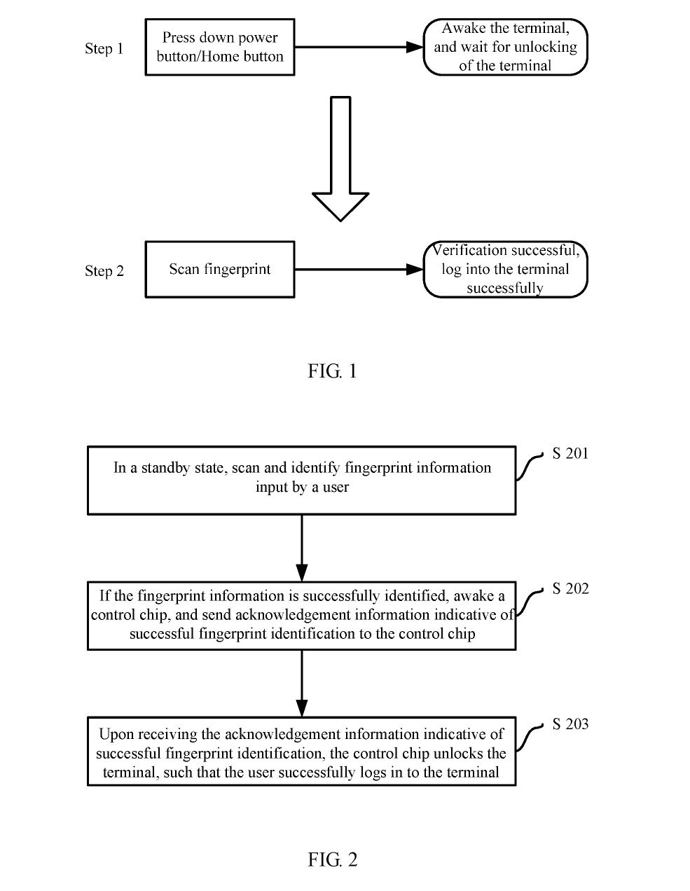

Quick login may be implemented via a one-step operation according to the above two embodiments. As illustrated in FIG. 6, it is apparent that as compared with the operations illustrated in FIG. 1, operation experience to the user is greatly enhanced.

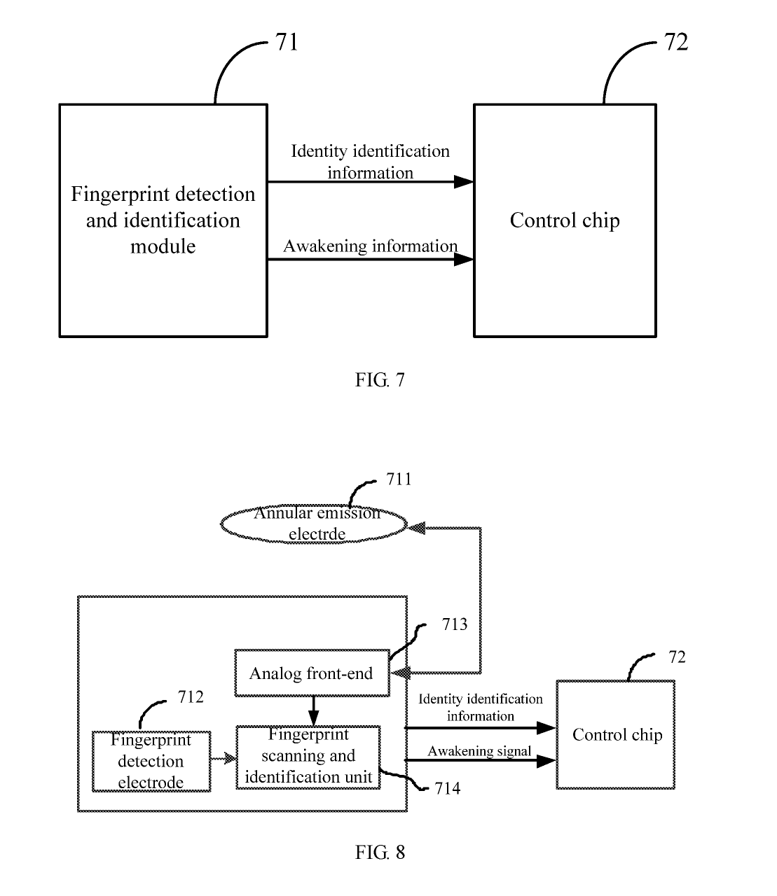

Referring to FIG. 7, a system for logging in to a terminal device based on fingerprint identification in a standby state includes a fingerprint detection and identification module 71 and a control chip 72. The fingerprint detection and identification module 71 is configured to, in a scanning and identification mode, scan and identify fingerprint information input by a user, and if the fingerprint information is successfully identified, awake the control chip 72 and send acknowledgement information indicative of successful fingerprint identification to the control chip 72. The control chip 72 is configured to upon receiving the acknowledgement information indicative of successful fingerprint identification, unlock the terminal device, to enable the user to successfully log in to the terminal.

As described above, to reduce overall power consumption, the above scanning and identification mode is enabled only when a touch operation is performed. Therefore, the fingerprint detection and identification module 71 is configured to, firstly in the standby state, detect whether the user performs a touch operation, and enter a scanning and identification mode if it is detected that the user performs the touch operation.

Further, the fingerprint detection and identification module 71, in the standby state, specifically detects whether the user performs a touch operation conforming to rules, for example, a long-press touch operation, a short-press double-tap operation or the like as illustrated in FIG. 3A and FIG. 3B.

If detecting no touch operation conforming to the rules, the fingerprint detection and identification module 71 enters a period of sleep time and temporarily stops the touch gesture detection step.

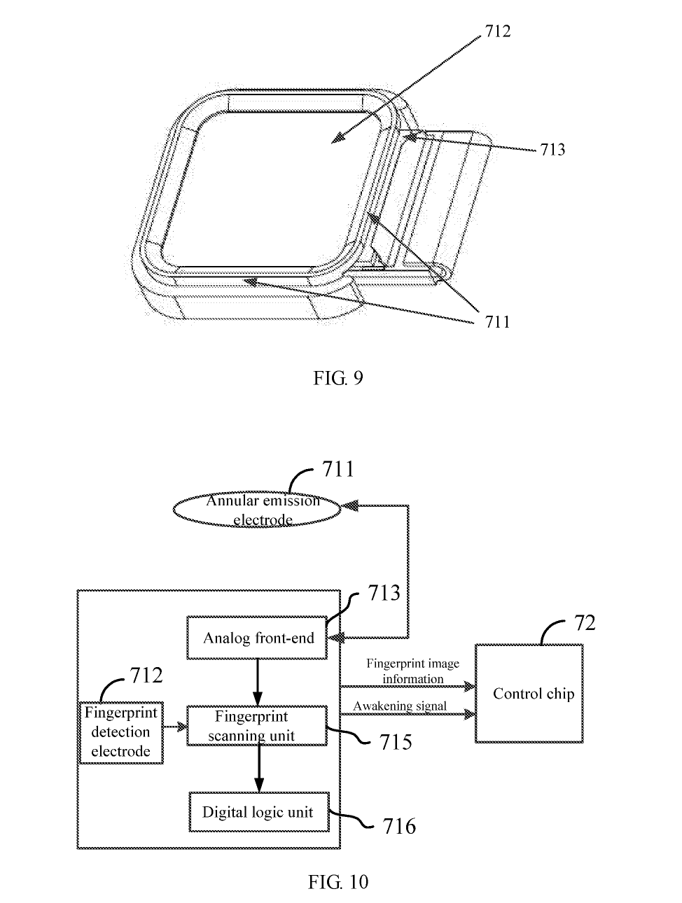

FIG. 8 illustrates a schematic diagram of a system for logging in a terminal device based on fingerprint identification in a standby state according to the first embodiment of the present invention; and FIG. 9 illustrates an appearance diagram of a fingerprint detection and identification module according to the present invention. Referring to FIG. 8 and FIG. 9, the fingerprint detection and identification module 71 includes an annular emission electrode 711, a fingerprint detection electrode 712, an analog front-end 713 and a fingerprint scanning and identification unit 714. The fingerprint detection electrode 712 may be an m*n electrode array. The analog front-end 713 is connected to the annular emission electrode 711, and configured to detect, in the standby state, whether the user performs a touch operation on the annular emission electrode 711. The fingerprint scanning and identification unit 714 is connected to the fingerprint detection electrode 712 and the analog front-end 713, and is configured to, after the analog front-end 713 detects the touch operation performed by the user, enter a scanning and identification mode to scan and identify fingerprint information input by the user via the fingerprint detection electrode 712, awake the control chip 72 upon successful fingerprint information identification, and send acknowledgement information indicative of successful fingerprint identification to the control chip 72.

To improve a speed of detection, scanning and identification of the fingerprint detection and identification module 71, in the present invention, the annular emission electrode 711 is arranged to surround the fingerprint detection electrode 712, and the finger may simultaneously touch the annular emission electrode 711 and the fingerprint detection electrode 712. Once being touched by a finger, the analog front-end 713 and the fingerprint scanning and identification unit 714 may be enabled substantially at the same time.

As an example of the present invention, the analog front-end 713 is implemented by an operational amplifier, wherein a non-inverting input terminal of the operational amplifier is connected to a reference potential Vref, an inverting input terminal thereof is connected to the annular emission electrode 711, and an output terminal thereof is connected to the fingerprint scanning and identification unit 714. Moreover, a capacitor C and a resistor R are arranged in parallel between the inverting input terminal and the output terminal, and the inverting input terminal is also connected to an alternating current drive source so as to drive the annular emission electrode 711.

When the finger touches the annular emission electrode 711, a parasitic capacitance between the annular emission electrode 711 and a remote ground may be altered, and whether the finger touches a fingerprint sensor may be detected by means of detecting the parasitic capacitance.

As illustrated in FIG. 10, a system for logging into a terminal device based on fingerprint identification in a standby state according to the second embodiment of the present invention is different from the first embodiment in that the fingerprint identification is implemented by the control chip 72, and a fingerprint scanning and detection module, which is formed by the annular emission electrode 711, the fingerprint detection electrode 712, the analog front-end 713, the fingerprint scanning unit 715 and a digital logic unit 716, is configured to detects, in the standby state, whether a user performs a touch operation. The fingerprint scanning and detection module is also configured to upon detection of a touch operation performed by the user, enter a fingerprint scanning mode to scan whether the user inputs fingerprint information; if it is scanned that the user inputs fingerprint information, awake the control chip and send the scanned fingerprint information to the control chip 72, and digitalize the scanned fingerprint information and send the fingerprint information to the control chip 72. Afterwards, the control chip 72 identifies the fingerprint information, and unlocks the terminal device upon successful fingerprint identification, to enable the user to successfully log into the terminal device.

The above login system may be a software unit, a hardware unit or a software-hardware hybrid unit built in the terminal device such as a mobile phone, a tablet computer and the like. The mobile terminal may include a display screen, a touch screen, a fingerprint scanning module/fingerprint scanning and identification module and a primary controller. The fingerprint scanning module/fingerprint scanning and identification module, in the standby state, enters a low power-consumption working mode instead of a sleep mode, and may scan or even identify the fingerprint once detecting a valid touch operation, thereby saving manual awaking before the scanning and identification function is enabled. In this way, user experience is improved.

It is understandable to those skilled in the art that all or partial steps of the method described in the above embodiments can be implemented by controlling relevant hardware by programs. The programs may be stored in a computer readable storage medium. The storage medium may be a read-only memory (ROM), random access memory (RAM), a magnetic disk or a compact disc read-only memory (CD-ROM).

The above descriptions are merely preferred embodiments of the present invention, but not intended to limit the present invention. Any modification, equivalent replacement, and improvement made without departing from the spirit and principle of the present invention shall fall within the protection scope of the present invention.

What is claimed is:

1. A method for logging into a terminal device based on fingerprint identification in a standby state, comprising:
detecting, in the standby state, whether a touch operation is performed by a user on the terminal device;
scanning, when the touch operation is detected, fingerprint information input by the user;
awaking a control chip upon successful identification of the fingerprint information and sending acknowledgement information indicative of successful fingerprint identification to the control chip; or, awaking the control chip when the fingerprint information is scanned and identifying the fingerprint information by the control chip; and
unlocking, by the control chip, the terminal device to enable the user to log into the terminal device when the fingerprint information is successfully identified.

2. The method for logging into a terminal device based on fingerprint identification in a standby state according to claim 1, wherein the fingerprint information input by the user is scanned in a fingerprint scanning mode, and the fingerprint scanning mode is not enabled before detection of the touch operation performed by the user.

3. The method for logging into a terminal device based on fingerprint identification in a standby state according to claim 2, wherein
a touch operation conforming to rules corresponding to specific touch operation gesture is considered as a valid touch operation.

4. The method for logging into a terminal device based on fingerprint identification in a standby state according to claim 3, wherein the touch operation conforming to the rules comprises a tap operation, a long-press touch operation or a short-press double-tap operation.

5. The method for logging into a terminal device based on fingerprint identification in a standby state according to claim 3, wherein if no touch operation conforming to the rules is detected, the terminal device enters a period of sleep time and temporarily stops detecting whether a touch operation is performed.

6. A system for logging into a terminal device based on fingerprint identification in a standby state, comprising a fingerprint detection and identification module and a control chip; wherein:
the fingerprint detection and identification module is configured to scan and identify fingerprint information input by a user, and if the fingerprint information is successfully identified, awake the control chip and send acknowledgement information indicative of successful fingerprint identification to the control chip; and
the control chip is configured to, upon receiving the acknowledgement information indicative of successful fingerprint identification, unlock the terminal device to enable the user to log into the terminal device.

7. The system for logging into a terminal device based on fingerprint identification in a standby state according to claim 6, wherein the fingerprint detection and identification module is further configured to, in the standby state, detect whether the user performs a touch operation, and enter a scanning and identification mode if it is detected that the user performs a touch operation.

8. The system for logging into a terminal device based on fingerprint identification in a standby state according to claim 7, wherein the fingerprint detection and identification module is further configured to, in the standby state, detect whether the user performs a touch operation conforming to rules corresponding to specific touch operation gesture is considered as a valid touch operation.

9. The system for logging into a terminal device based on fingerprint identification in a standby state according to claim 8, wherein the touch operation conforming to the rules comprises a tap operation, a long-press touch operation or a short-press double-tap operation.

10. The system for logging into a terminal device based on fingerprint identification in a standby state according to claim 8, wherein the fingerprint detection and identification module is further configured to, if no touch operation conforming to the rules is detected, enter a period of sleep time and temporarily stop detecting whether a touch operation is performed.

11. The system for logging into a terminal device based on fingerprint identification in a standby state according to claim 7, wherein the fingerprint detection and identification module comprises:
an annular emission electrode;
a fingerprint detection electrode;
an analog front-end, connected to the annular emission electrode, and configured to detect, in the standby state, whether the user performs a touch operation on the annular emission electrode; and
a fingerprint scanning and identification unit, connected to the analog front-end and the fingerprint detection electrode, and configured to, after the analog front-end detects the touch operation performed by the user, enter a scanning and identification mode to scan and identify fingerprint information input by the user via the fingerprint detection electrode, awake the control chip upon successful fingerprint information identification, and send acknowledgement information indicative of successful fingerprint identification to the control chip.

12. The system for logging into a terminal device based on fingerprint identification in a standby state according to claim 11, wherein the annular emission electrode is arranged to surround the fingerprint detection electrode, and the annular emission electrode and the fingerprint detection electrode are simultaneously touchable by a finger.

13. A terminal device based on fingerprint identification, comprising a system for logging into a terminal device based on fingerprint identification in a standby state, the system comprising a fingerprint scanning and detection module and a control chip; wherein:
the fingerprint scanning and detection module is configured to detect whether a user performs a touch operation in the standby state, enter a fingerprint scanning mode to scan whether the user inputs fingerprint information upon detection of a touch operation performed by the user, and awake the control chip and send the scanned fingerprint information to the control chip if it is scanned that the user inputs fingerprint information, and
the control chip is configured to identify the fingerprint information, and unlock the terminal device upon successful fingerprint identification to enable the user to log into the terminal device.

14. The terminal device based on fingerprint identification according to claim 13, wherein the fingerprint scanning and detection module comprises:
an annular emission electrode;
a fingerprint detection electrode;
an analog front-end connected to the annual emission electrode;
a fingerprint scanning unit connected to the analog front-end and the fingerprint detection electrode; and
a digital logic unit connected to the fingerprint scanning unit.

15. The terminal device based on fingerprint identification according to claim 14, wherein the annular emission electrode is arranged to surround the fingerprint detection electrode, and the annular emission electrode and the fingerprint detection electrode are simultaneously touchable by a finger.
